(19) United States
(12) Patent Application Publication
(10) Pub. No.: US 2009/0240369 A1
(43) Pub. Date: Sep. 24, 2009

(54) METHOD AND APPARATUS FOR RANDOMIZED RECORD STORAGE USING BIDIRECTIONAL SHIFTING

(75) Inventors: Eric Meyerhofer, Pasadena, CA (US); Kevin Rainbolt, Glendale, CA (US); Angel Rosales, Oxnard, CA (US)

Correspondence Address: FITZPATRICK CELLA HARPER & SCINTO, 30 ROCKEFELLER PLAZA, NEW YORK, NY, 10112, US

(73) Assignee: FUTURELOGIC, INC., Glendale, CA (US)

(21) Appl. No.: 12/090,481

(22) PCT Filed: Oct. 20, 2006
(86) PCT No.: PCT/US06/41103

§ 371 Date: Feb. 10, 2009

(30) Foreign Application Priority Data
Oct. 20, 2005 (US) 60728992

(51) Int. Cl. G06F 17/00

(52) U.S. Cl. 700/214

(57) ABSTRACT

Method and apparatus for randomized record storage using bidirectional shifting wherein a printer is coupled to a conveyor system housed in a temporary storage bin. The conveyor system shifts in a bidirectional fashion to randomize the order of the printouts temporarily stored in the temporary storage bin and prevent the storage of sequentially generated printouts in a storage tray.

### CROSS-REFERENCE TO RELATED APPLICATIONS

The present application claims the benefit us U.S. Provisional Application No. 60/728,992 filed Oct. 20, 2005, the contents of which are incorporated by reference as if stated in full herein.

### BACKGROUND OF THE INVENTION

1. Field of the Invention

This invention relates to a printer coupled to a conveyor system housed in a temporary storage bin wherein the conveyor system shifts in a bidirectional fashion to randomize the order of the printouts temporarily stored in the temporary storage bin and prevent the storage of sequentially generated printouts in a storage tray.

2. Background

Currently, printers such as printers used for voting purposes do not have a mechanism in use which can randomize the order of printouts generated by the printer to prevent the storage of sequentially generated printouts in a storage tray. This presents a problem whereby the voting may not be anonymous at the voting order can be determined based on the order of the printouts in a storage tray.

This invention addresses this issue by disclosing a method and apparatus which can shift the order of the printouts prior to the printouts being placed in a storage tray, thereby randomizing the print order.

### DEFINITIONS

For the purposes of this document the following definitions apply:

“TRP”—an abbreviation for Transaction Record Printer.

“Transaction Record”—a voter ballot, a receipt, or any other record or printout of conducted business.

### FEATURES OF THE INVENTION

A method and apparatus for randomized record storage using bidirectional shifting wherein a printer is coupled to a conveyor system housed in a temporary storage bin are provided. The conveyor system shifts in a bidirectional fashion to randomize the order of the printouts temporarily stored in the temporary storage bin and prevent the storage of sequentially generated printouts in a storage tray.

The invention may include various optional aspects or features that are readily combinable in various ways to create various exemplary embodiments of the invention. In one aspect of the invention, a Transaction Record Printer (herein referred to as “TRP”) includes a print mechanism, nonvolatile memory, a record view window, a supply tray, supply paper, a paper path, one or more sensors, procedures, a cutter, rollers, transaction records, conveyor system, a temporary storage bin, a storage tray, one or a plurality of processors, and one or a plurality of controllers.

In another aspect of the invention, the TRP randomizes the storage of transaction records using bidirectional paper shifting. Before a print command is issued, the TRP shifts in a bidirectional fashion the conveyor system containing a plurality of transporters holding transaction records, thereby distributing the transaction records between the transporters, thus creating randomness in the storage of the transaction records. After a print command is issued, the TRP pulls from the supply paper in a supply tray through a printing mechanism wherein the supply paper is encoded with transaction data to create a transaction record. The transaction record is pulled along the paper path, passed by a record view window, and is separated from the supply paper before the transaction record is placed into a transporter area of the conveyor system housed in the temporary storage bin.

In another aspect of the invention, the TRP is coupled to a controller and the controller sends and receives signaling from other components of the TRP such as the print mechanism and conveyor system.

In another aspect of the invention, the controller is coupled to a controller in the conveyor system. The TRP controller includes the mechanisms to:
a) generate a transaction record or plurality of such.
b) void a transaction record or plurality of such.
c) shift the conveyor system in a bidirectional fashion, the bidirectional fashion being shift up or shift down
d) send signaling to the conveyor system or the controller of the conveyor system to shift to another transporter in the conveyor system.
e) receive signaling from the conveyor system or the controller of the conveyor system that the shift to another transporter has occurred.
f) send signaling to the conveyor system or the controller of the conveyor system to shift to allow transaction records in a transporter to be transferred to a storage tray.
g) receive signaling from the conveyor system or the controller of the conveyor system that the transfer of transaction records in a transporter has occurred or the transporter is empty.

In another aspect of the invention, the temporary storage bin includes the mechanisms by which transaction records generated by the TRP are temporarily stored prior to being transported to a storage tray.

In another aspect of the invention, the temporary storage bin is coupled to a conveyor system, the conveyor system including the mechanisms to shift transaction records to create randomized storage of the transaction records.

In another aspect of the invention, the temporary storage bin is coupled to an entry point, the entry point including the mechanisms by which transaction records are transported into a conveyor system.

In another aspect of the invention, the temporary storage bin is coupled to a storage tray, the storage tray including the mechanisms by which to store transaction records transported from a conveyor system.

In another aspect of the invention, a conveyor system is coupled to a plurality of transporters, the transporters holding a certain number of transaction records generated by the TRP.

In another aspect of the invention, a conveyor system includes the mechanisms to shift in a bidirectional fashion to create randomness in the storage of transaction records.

In another aspect of the invention, a print mechanism includes the mechanisms to print transaction records on the supply paper, the print mechanism being a non-impact type such as thermal, laser, inject, or dye-sublimation, or impact type such as dot matrix.

In another aspect of the invention, nonvolatile memory includes the mechanisms to record the size of a transaction record, the gap size between transaction records, and/or the number of lines to print.

In another aspect of the invention, a record view window includes the mechanisms by which users may view their transaction record.

In another aspect of the invention, a random generator in the TRP may determine the procedure to use in the bidirectional shifting of the conveyor system for randomizing the print order of transaction records before sequentially printing transaction records.

In another aspect of the invention, a supply tray includes the mechanisms to store supply paper.

In another aspect of the invention, the supply paper may include preprinted indicia such as index markers, the preprinted indicia either on the thennal sensitive or non-thermal sensitive side of the supply paper.

In another aspect of the invention, the supply paper includes fanfolded perforated paper that the TRP may burst after printing, the supply paper being of a fixed dimension, such as length and width.

In another aspect of the invention, the paper path includes a print mechanism, a supply tray, a record view window, a cutter, one or a plurality of sensors, one or a plurality of rollers, a temporary storage bin, and a storage tray.

In another aspect of the invention, the TRP coupled to a sensor or plurality of such includes the mechanisms to scan and read the front (or thermal sensitive) side of the supply paper for indicia such as beginning and end of form markers.

In another aspect of the invention, the TRP coupled to a sensor or plurality of such includes the mechanisms to scan and read the back (or non-thermal sensitive) side of the supply paper for indicia such as index markers.

In another aspect of the invention, a cutter includes the mechanisms to separate or burst the transaction record from the supply paper upon signaling from the TRP, prior to the transaction record being transported to a temporary storage bin.

In another aspect of the invention, rollers include the mechanisms for guiding a transaction record through the paper path to the temporary storage bin.

In another aspect of the invention, procedures may be used to signal a cutter in the TRP that a transaction is complete, after which the cutter separates the transaction record from the supply paper.

In another aspect of the invention, procedures may be used to identify the attributes of a transaction record, the attributes stored in nonvolatile memory.

In another aspect of the invention, procedures may be used to set the conveyor system to shift in a bidirectional fashion, the shifting of which may be stored in nonvolatile memory.

In another aspect of the invention, procedures are used to signal the TRP to generate a transaction record.

In another aspect of the invention, procedures are used to signal the TRP to shift in a bidirectional fashion the conveyor system.

In another aspect of the invention, procedures may be used to void over a transaction record.

In another aspect of the invention, the TRP includes the mechanisms to void a transaction record, whereby a sensor or a plurality of such is used to read encoding on a transaction record, after which procedures are used to retract the transaction record through the paper path and return the transaction record to the print mechanism. The print mechanism prints over the transaction record with a VOID stamp after which the transaction record is pulled along the paper path, separated from the supply paper by the cutter, and transported to the temporary storage bin for eventual transfer to a storage tray.

In another aspect of the invention, the transaction record includes indicia such as text or a plurality of text such as ballot information or graphics or a plurality of graphics such as the logo of a governing agency or business entity.

In another aspect of the invention, the indicia for index markers may be used to identify the beginning of a form, the end of a form, or a combination thereof.

In another aspect of the invention, the indicia may be situated on the front of the transaction record, the back of the transaction record, or a combination thereof.

In another aspect of the invention, the indicia may be generated simultaneously with the generation of a transaction record.

### BRIEF DESCRIPTION OF THE DRAWINGS

These and other features, aspects, and advantages of the invention will become better understood with regard to the following description and accompanying drawings where:

FIG. 1 is a partial cutaway perspective view of a TRP in accordance with an exemplary embodiment of the invention.

FIG. 2 is a schematic side view of a TRP and components thereof in accordance with an exemplary embodiment of the invention.

FIG. 3 is a schematic frontal view of a temporary storage bin, components thereof, and a storage tray of the TRP in accordance with exemplary embodiment of the invention.

FIG. 4 is an illustration of how transaction records are transported from a temporary storage bin using a conveyor system to a storage tray of the TRP in accordance with an exemplary embodiment of the invention.

FIG. 5 is a cutaway side view of a TRP illustrating temporary storage of a transaction record in accordance with an exemplary embodiment of the invention.

FIG. 6 is a cutaway side view of a TRP illustrating the movement of a transaction record in accordance with an exemplary embodiment of the invention.

FIG. 7 is a cutaway side view of a TRP illustrating the storage of additional transaction records in accordance with an exemplary embodiment of the invention.

FIG. 8 is a cutaway side view of permanent storage of a transaction record in accordance with an exemplary embodiment of the invention.

FIG. 9 is a table of parameters that may be used with procedures for randomized bidirectional shifting or transaction record characteristics, in accordance with an exemplary embodiment of the invention.

FIG. 10 is a process flow diagram for the procedures used in printing, voiding, and bursting a transaction record process in accordance with an exemplary embodiment of the invention.

FIG. 11 is a process flow diagram for randomized bidirectional shifting using procedures and a conveyor system in accordance with an exemplary embodiment of the invention.

FIG. 12 is an illustration of the front side of a transaction record including indicia in accordance with an exemplary embodiment of the invention.

FIG. 13 is an illustration of the back side of a transaction record including indicia in accordance with an exemplary embodiment of the invention.

FIG. 14 is an illustration of the face of a transaction record including indicia and a VOID stamp in accordance with an exemplary embodiment of the invention.

FIG. 15 is an illustration of a record view window of a TRP in accordance with an exemplary embodiment of the invention.

Identically labeled elements appearing in different ones of the figures refer to the same elements but may not be referenced in the description for all figures.

### DETAILED DESCRIPTION

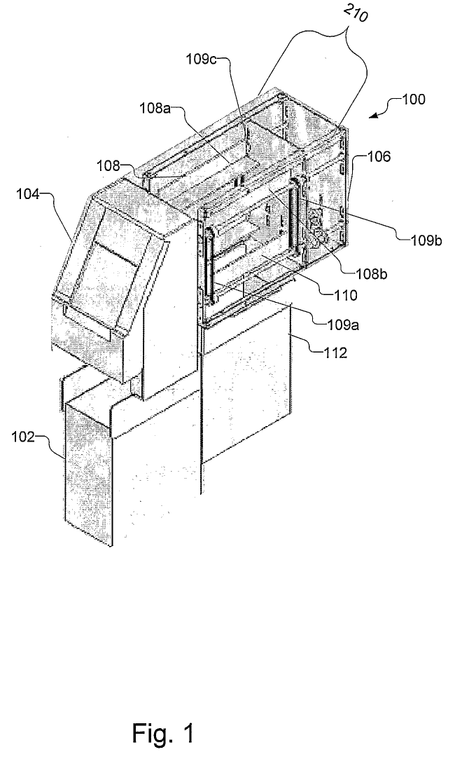

FIG. 1 is a partial cutaway perspective view of a TRP in accordance with an exemplary embodiment of the invention. A TRP 100 includes a supply tray 102 holding supply paper. The supply tray feeds supply paper to a printer mechanism 104 that prints transaction records on the supply paper. The completed transaction record is printed and then fed into a temporary storage bin 106. The temporary storage bin includes a conveyor system 210 having a plurality of transporters, such as transporters 108 and 110. The transporters are operable to receive the printed transaction records and transport them to a storage tray 112.

Each transporter includes one or more ledges, such as ledges 108a and 108b of transporter 108, that are carried on one or more motorized conveyor belts or chains, such as conveyor belts 109a, 109b and 109c. Although being described herein as having either two or three transporters, it is to be understood that any number of transporters may be incorporated into the conveyor system.

In operation, the TRP prints transaction records and stores them temporarily in the transporters. The transporters may be moved in a random or predetermined fashion or pattern to receive the transaction records out of order. The transporters are also operable to transport the transaction records to the storage tray for longer term storage.

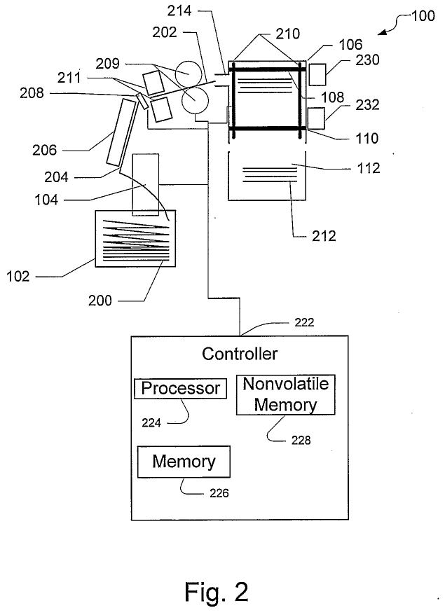

Having described the basic components and operation of a TRP in accordance with an exemplary embodiment of the invention, a more detailed description will be made with reference to FIG. 2. FIG. 2 is a schematic side view of a TRP and components thereof in accordance with an exemplary embodiment of the invention. The TRP 100 includes supply paper 200 held in a supply tray 102. The supply paper is taken up by a print mechanism 104. The print mechanism prints a transaction record 202 that is fed through a paper path 204. The transaction record travels through a record view window 206 before the transaction record is separated from the supply paper by a cutter 208. The transaction record is then fed into a temporary storage bin 112 having a plurality of transporters, 108 and 110, mounted within a conveyor system 210. Completed transaction records 212 are stored in the storage tray for later retrieval.

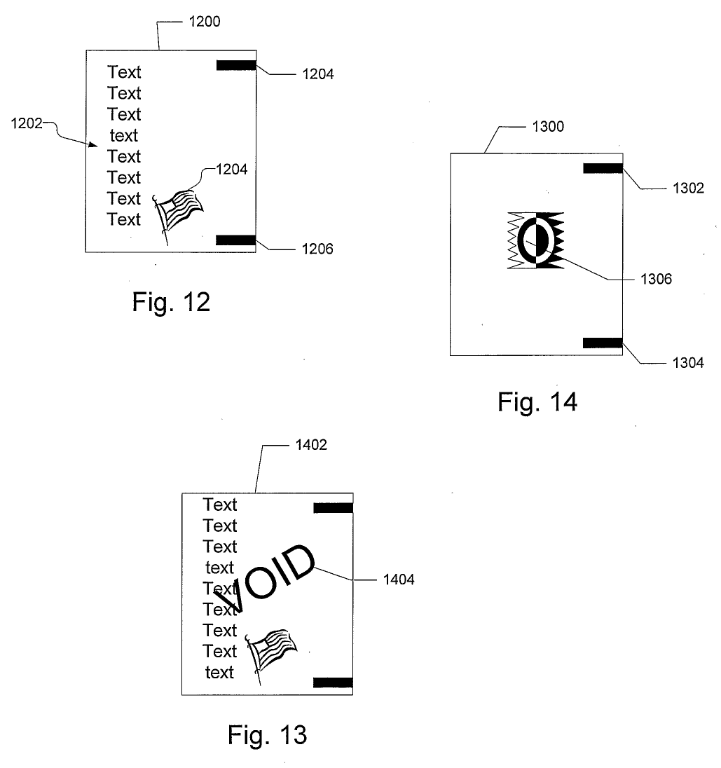

In operation, transaction records, as later described in FIG. 12, FIG. 13, and FIG. 14, are generated on the supply paper as the supply paper passes through the print mechanism. The supply paper may include preprinted indicia such as beginning and end of form markers, the preprinted indicia either on a printable side (for example, a thermal sensitive side) or a non-printable side (for example a non-thermal sensitive side) of the supply paper. The supply paper may be fanfolded paper which may be perforated or the TRP may burst the transaction record from the paper supply after printing, the supply paper being of a fixed dimension, such as length and width.

The supply tray is used to store supply paper until such time the TRP signals to create a transaction record. A print mechanism may be used to print transaction records on the supply paper. The print mechanism may be a non-impact type such as thermal, laser, inkjet, or dye-sublimation, or impact type such as dot matrix.

The paper path includes supply paper from the supply tray traveling through the print mechanism, under the record view window, through the cutter and rollers 209, through an entry point 214 into the temporary storage bin, and ending in the storage tray.

The paper path may further include one or more sensors 211. The sensors may be used to scan either the front side, the back side or both sides of the transaction record. This allows the transaction record to be verified after printing and tracked as the transaction record passes through the paper path.

The conveyor system may further include one or more sensors, 230 and 232, that are used to sense the position of the transporters. This allows the TRP to determine whether or not the transporters are operating properly as well as know which transporters are in position to receive a transaction record.

The record view window is used by users to view their transaction record prior to the TRP bursting the transaction record from the supply paper.

The cutter is used to separate the transaction record from the supply paper upon signaling from the TRP, prior to the transaction record being transported through the entry point to the temporary storage bin for temporary storage. The rollers are used to guide a transaction record through the paper path and the entry point to the temporary storage bin for temporary storage.

The temporary storage bin is used to temporarily store transaction records generated by the TRP prior to the transaction records being transported to a storage tray. The temporary storage bin is coupled to an entry point, where the entry point is used to transport transaction records into the transporters of the conveyor system. The temporary storage bin is coupled to a conveyor system. The conveyor system is used to shift transaction records in a bidirectional fashion to create randomized storage of the transaction records that are distributed to the transporters. The conveyor system includes the plurality of transporters, where the transporters are used to hold a certain number of transaction records generated by the TRP until the transaction records are transported to a storage tray. Finally, the temporary storage bin is coupled to a storage tray, where the storage tray is used to store transaction records transported from a conveyor system in the temporary storage bin.

A controller 222 controls the operation of the components of the TRP 100. The controller is coupled to the motorized paper rollers, the print mechanism, the cutter and the conveyor system. The controller includes a processor 224 coupled to a memory 126 holding data and processor executable instructions executable by the processor to implement the features of a TRP as described herein. The controller further includes a nonvolatile memory 228 for storing parameter values for transaction records printed by the TRP.

Although described in terms of a controller having a processor, a memory and executable memory instructions, it is to be understood that the controller 222 can be implemented using any device capable of executing a logical operation, such as a general purpose computer, a preprogrammed logic controller, one or more hardware circuits, etc. Furthermore, multiple controllers may be employed in the TRP to operate the TRP and its components in a distributed manner.

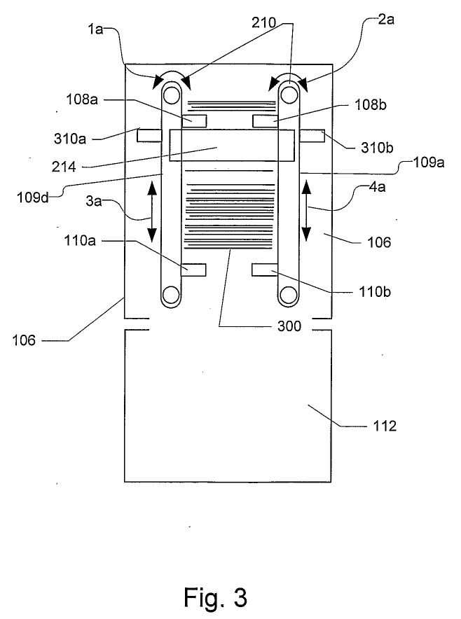

The operation of the conveyor system 210 will now be described with reference to FIG. 3. FIG. 3 is a frontal view of the temporary storage bin 106, components thereof, and a storage tray 112 of the TRP in accordance with exemplary embodiment of the invention. Arrows 1a, 2a, 3a, and 4a illustrate how the conveyor system 210 shifts in a bidirectional fashion to create randomness in the storage of transaction records. The conveyor system includes a plurality of conveyor belts or chains, two of which are shown, 109a and 109d. A transporter includes a pair of ledges coupled to the belts such that a pair of ledges constitute a single transporter. For example, ledges 110a and 110b constitute a transporter 110 (of FIG. 2). When the ledges are on an inside portion of the conveyor belts, the ledges face each other such that a stack of transaction records 300 may be held therebetween. By driving the conveyor belts, as shown by arrows 1a and 2a, the ledges forming the transporter can be moved up and down, as indicated by arrows 3a and 4a.

Furthermore, when the conveyor belts are driven such that ledges forming a transporter are on an outside portion of the conveyor system, such as ledges 310a and 310b, the ledges face away from each other. Therefore, the transporter created by the ledges 310a and 310b is no longer able to hold transaction records.

Upon signaling from the TRP, the conveyor system shifts a transporter above entry point 214, such as the transporter created by ledges 108a and 108b, to allow a transaction record or a plurality of such to be placed in another transporter. The conveyor system also may shift a transporter down below the entry point to allow a transaction record or plurality of such being transported to be placed in the transporter, for example the transporter created by ledges 110a and 110b. In this way, the TRP may select to which transporter an individual transaction record or group of transaction records are stored.

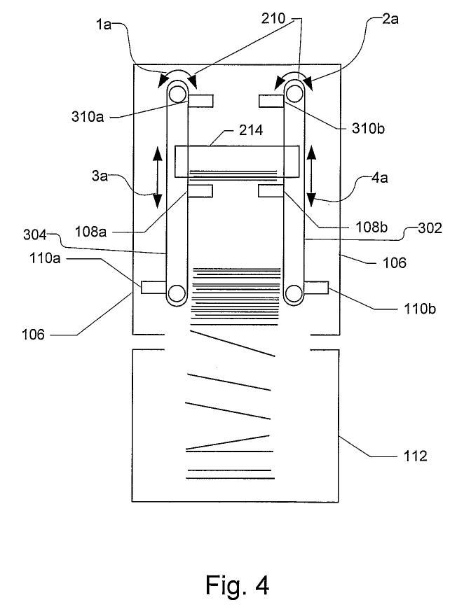

When the space designated for holding transaction records in a transporter, such as the transporter created by ledges 110a and 110b, is exhausted and can no longer hold transaction records, the TRP signals the conveyor system to shift, thereby transporting the transaction records in such a transporter to the storage tray as later described in FIG. 4.

Turning now to FIG. 4, FIG. 4 is an illustration of how transaction records are transported from the temporary storage bin using a conveyor system to a storage tray of the TRP in accordance with an exemplary embodiment of the invention. As previously discussed in reference to FIG. 3, when the space designated for each transporter, such as the transporter created by ledges 110a and 110b, is exhausted and can no longer hold transaction records, the TRP using procedures and one or a plurality of processors signals the conveyor system to shift the transporter created by ledges 110a and 110b downward such that ledges 110a and 110b are now on an outside portion of the conveyor system. As illustrated in FIG. 4, upon shift of the conveyor system, the transaction records in the transporter created by ledges 110a and 110b are transported to the storage tray by dropping the transaction records from the transporter created by ledges 110a and 110b. After dropping the transaction records into the storage tray, ledges 110a and 110b are then situated on the outside of the conveyor system while ledges 310a and 310b are now situated on the inside of the conveyor system thus creating a new transporter able to receive transaction records.

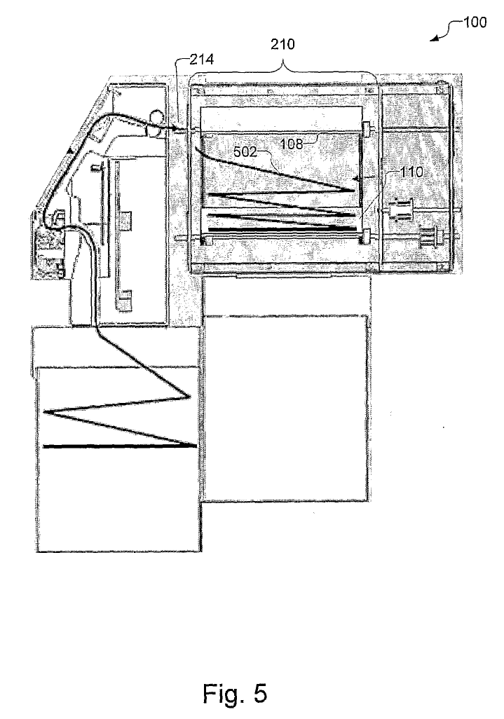

Having described the operation of the conveyor system, the operation of the TRP during transaction record storing will now be described with reference to FIGS. 5, 6, 7 and 8. FIG. 5 is a cutaway side view of a TRP illustrating temporary storage of a transaction record in accordance with an exemplary embodiment of the invention. Upon signaling from the TRP 100, the conveyor system 210 shifts transporter 108 above entry point 214. The conveyor system also may shift a transporter down below the entry point to allow a transaction record or plurality of such being transported to be placed in the transporter, for example transporter 110. In this way, the TRP may select to which transporter an individual transaction record or group of transaction records are stored.

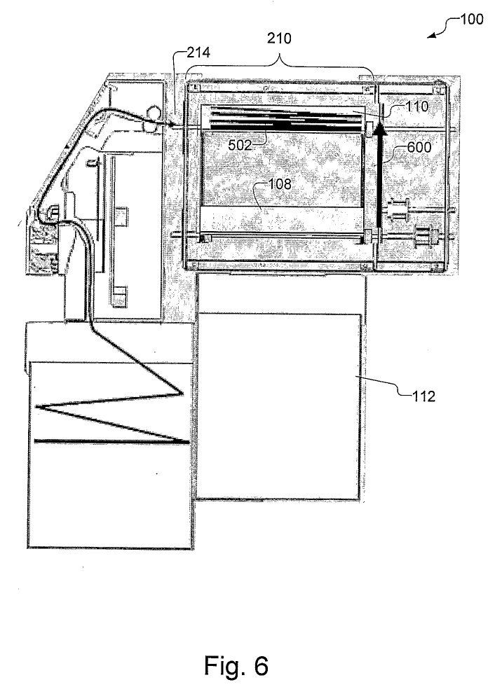

Turning now to FIG. 6, FIG. 6 is a cutaway side view of a TRP illustrating the movement of a transaction record in accordance with an exemplary embodiment of the invention. Upon signaling from the TRP 100, the conveyor system shifts, as indicated by arrow 600, transporter 110 above the entry point 214 without releasing the transaction records 502 that are stored in transporter 110.

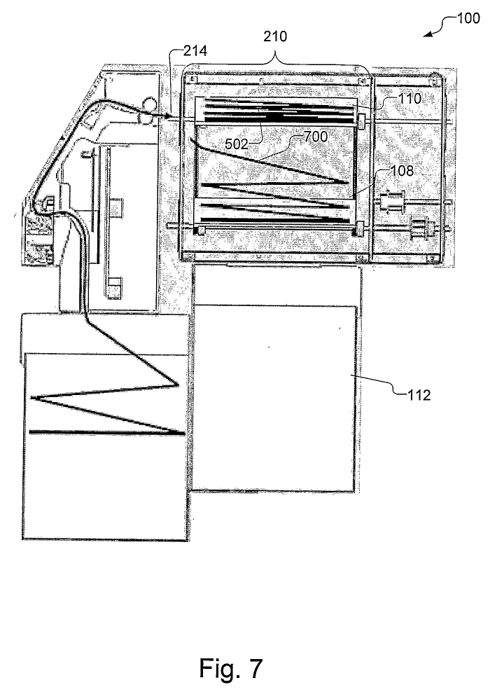

FIG. 7 is a cutaway side view of a TRP illustrating the storage of additional transaction records in accordance with an exemplary embodiment of the invention. As the TRP prints additional transaction records 700, they are stored in the lowered transporter 108 as transporter 108 is now below the entry point 214. The conveyor system 210 holds transporter 110 above the entry point without releasing the transaction records 502.

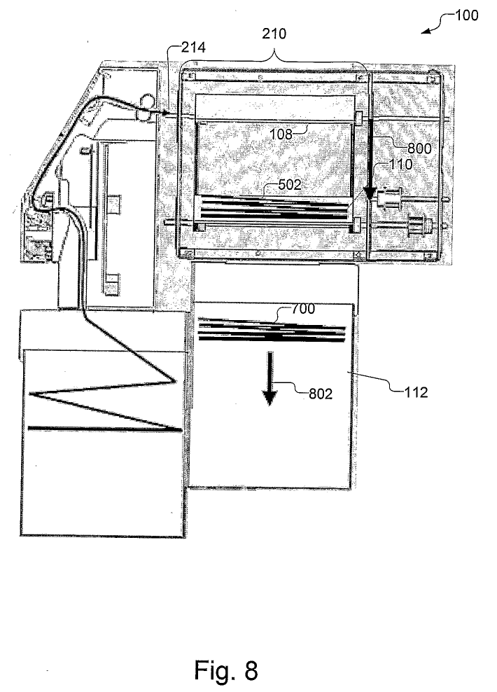

FIG. 8 is a cutaway side view of permanent storage of a transaction record in accordance with an exemplary embodiment of the invention. When the space designated for holding transaction records in a transporter, such as 108, is exhausted and can no longer hold transaction records, the TRP 100 signals the conveyor system 210 to shift transporter 110 downward, as indicated by arrow 800, such that ledges (not shown) forming transporter 108 are moved away from each other to an outside portion of the conveyor system. This releases transaction records 700 that were held by transporter 108 to drop into storage tray 112. In a like manner, the TRP may signal the conveyor system to move transporter 110 down to the point that transporter 110 drops transaction records 502 into the storage tray 112 to be combined with transaction records 700. In this way, the transaction records are temporarily stored in the plurality of bidirectionaly shifted transporters such that the transaction records are distributed between the plurality of transporters. Periodically, or when the transporters become full, the transaction records from each of the transporters are combined by adding the transaction records to the single storage tray.

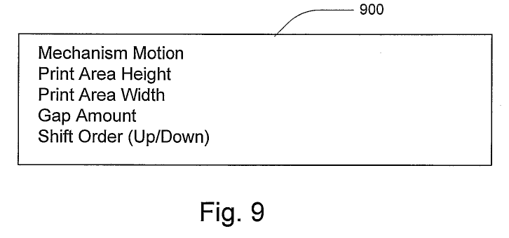

FIG. 9 is a table 900 of parameters that may be used with procedures for randomized bidirectional shifting or transaction record characteristics, in accordance with an exemplary embodiment of the invention. As shown, the possible parameters include Mechanism Motion, Print Area Height, Print Area Width, Gap Amount, and Shift Order. Any or all of these data elements and parameters may be stored in nonvolatile memory.

Mechanism Motion identifies the shift method used by the conveyor system. An example procedure for Random motion is:

Mechanism_Motion=(300,900)

where

(300,900)=the time range in seconds in which the motion in the conveyor system will occur.

Print Area Height identifies the height of the transaction records. The unit of measure may be any unit of measure for determining size.

Print Area Width identifies the width of the transaction records. The unit of measure may be any unit of measure for determining size.

An example procedure for print area information is:

Print_Area (2,5)

where

(2,5)=the Print Area Width and Print Area Height for transaction records.

Gap Amount identifies any gap or blank space between transaction records. The unit of measure may be any unit of measure for determining size.

Shift Order identifies the shift in the conveyor system as either up or down.

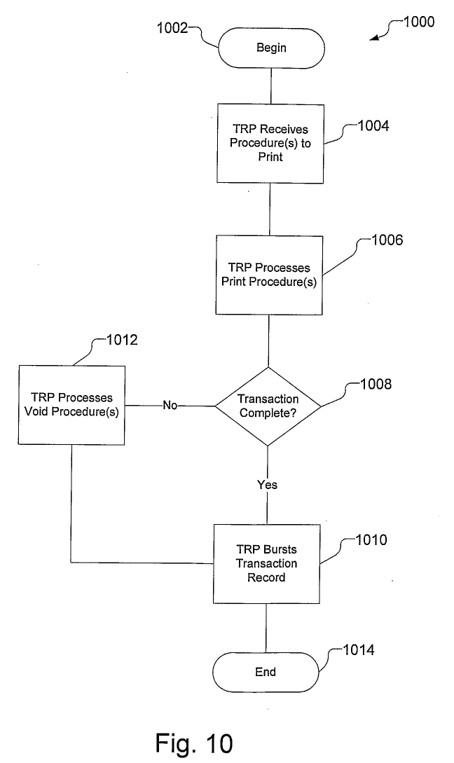

FIG. 10 is a process diagram for the procedures used in printing, voiding, and bursting a transaction record process in accordance with an exemplary embodiment of the invention. As shown, process 1000 begins (1002) with the TRP receiving (1004) procedures to begin printing a transaction record, after which the TRP processes (1006) the printing procedures to generate a transaction record. If the transaction is complete (1008), the TRP using a cutter or other bursting device bursts (1010) the transaction record from the supply paper. If the transaction is not complete or is erroneous, the TRP may void (1012) the transaction record before bursting it from the supply paper. The process then ends (1014).

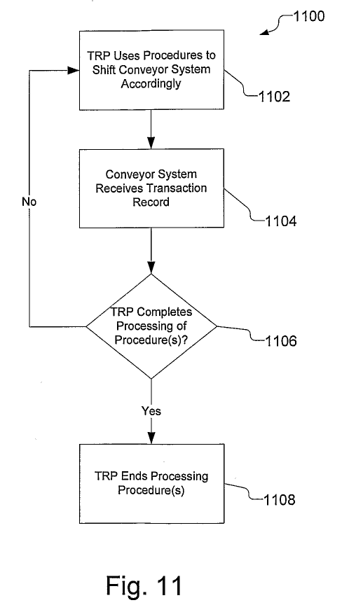

FIG. 11 is a process diagram for randomized bidirectional shifting using procedures and a conveyor system in accordance with an exemplary embodiment of the invention. As shown, process 1100 begins (1102) with the TRP using procedures to shift the conveyor system up or down to allow bidirectional shifting of the conveyor system to achieve randomized print order and storage, after which the conveyor system receives (1104) a transaction record. The process continues by either looping back to the procedure if the TRP has not completed (1106) processing the procedure or ending (1108) the process.

For example, procedures may be used to shift up the conveyor system to a transporter #1 to store a transaction record #1; shift down to a transporter #2 to store transaction records 2 thru 4; shift up transporter #1 to store transaction record 5; then shift down to return to transporter #2 for continuous transaction record holding until such time when the TRP using procedures transfers the transaction records from the temporary storage bin to the storage tray. Such a bidirectional shifting pattern may be predetermined and stored in a memory, such as memories 226 or 228 (both of FIG. 2) of the TRP or may be determined by a random number or pseudo random number generating procedure within the controller 222 (of FIG. 2) controlling the TRP.

An example the procedure for bidirectional shifting in a conveyor system is as follows:

+1<Shift1>+3<Shift2>+1<Shift3>

where:

Shift1=move the conveyor system down to transporter #2, whereupon transaction record 1 is received and temporarily stored.

Shift2=move the conveyor system up to transporter #1, whereupon transaction records 2 through 4 are received and temporarily stored.

Shift3=move the conveyor system down to transporter #2, whereupon sequentially generated transaction records are received and temporarily stored.

FIG. 12 is an illustration of the front side of a transaction record including indicia in accordance with an exemplary embodiment of the invention. As shown, a transaction record 1200 includes text 1202 or a plurality of such, a graphic 1204 or plurality of such, or a combination of text and graphics. Text may include a date, and/or a time. A graphic may be a barcode or a logo.

A transaction record may also include indicia such as index markers 1204 and 1206, tick marks, or a combination thereof, the indicia identifying a printed area or transaction record. The indicia may be preprinted on the supply paper or printed and encoded by the TRP simultaneously with the transaction record. The indicia may be read by an optical sensor or plurality of such to determine the beginning and end of a transaction record or the beginning or end of a transaction record. The indicia may be of a fixed value as determined by the attributes set using procedures, the attributes which may include length of the transaction record, number of lines to print, or tick marks, among others.

FIG. 13 is an illustration of the back side of a transaction record including indicia in accordance with an exemplary embodiment of the invention. As shown, a back side 1300 of a transaction record may include indicia such as index markers 1302 1304 or a logo 1306. The indicia and logo may be preprinted on the supply paper or printed and encoded by the TRP simultaneously with the transaction record.

FIG. 14 is an illustration of the face of a transaction record including indicia and a VOID stamp in accordance with an exemplary embodiment of the invention. As shown, a VOID stamp 1404 is printed over an existing transaction record 1402 such as that previously described in FIG. 7. For example, if the transaction record is to be voided, the TRP includes the mechanisms whereby a sensor or a plurality of such is used to read encoding on a transaction record, after which procedures are used to retract the transaction record through the paper path and return the transaction record to the print mechanism. The print mechanism prints over the transaction record with a VOID stamp after which the transaction record is pulled along the paper path, burst by the cutter, and transported to the temporary storage bin.

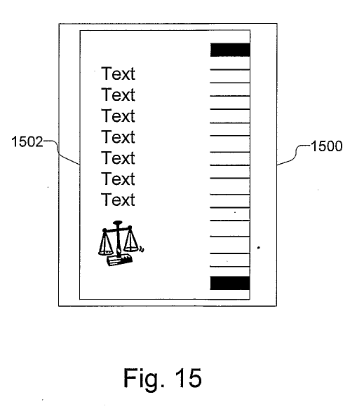

FIG. 15 is an illustration of a record view window of a TRP in accordance with an exemplary embodiment of the invention. A shown, a printed transaction record 1502 is presented for viewing using the record view window 1500 where a user may review the transaction record. For example, in a voting booth, after a voter casts their ballot, the voter may view the ballot using the record view window to determine if the ballot is correct. If the contents are incorrect, the TRP using procedures may return the transaction record to a print mechanism to void the transaction record and print a new transaction record after the user reenters ballot information.

Although the present invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

What is claimed is:

1. A method of storing transaction records printed by a transaction record printer, comprising:
storing the transaction records temporarily in a plurality of bidirectionaly shifted transporters such that the transaction records are distributed between the plurality of transporters; and
combining the transaction records from each of the transporters into a single storage tray.

2. The method of claim 1, wherein the transporters are shifted in a predetermined pattern.

3. The method of claim 1, wherein the transporters are shifted in a randomized pattern.

4. The method of claim 1, further comprising voiding an erroneously printed transaction record.

5. The method of claim 1, further comprising:
presenting a printed transaction record to a user for the user's review; and
voiding the printed transaction record if the printed transaction record is erroneous.

6. A transaction record printer for printing transaction records, comprising:
means for storing the transaction records temporarily in a plurality of bidirectionaly shifted transporters such that the transaction records are distributed between the plurality of transporters; and
means for combining the transaction records from each of the transporters into a single storage tray.

7. The transaction record printer of claim 6, further comprising means for shifting the transporters in a predetermined pattern.

8. The transaction record printer of claim 6, further comprising means for shifting the transporters in a randomized pattern.

9. The transaction record printer of claim 6, further comprising means for voiding an erroneously printed transaction record.

10. The transaction record printer of claim 6, further comprising:
means for presenting a printed transaction record to a user for the user's review; and
means for voiding the printed transaction record if the printed transaction record is erroneous.
